(19) United States
(12) Patent Application Publication
(10) Pub. No.: US 2015/0134450 A1
(43) Pub. Date: May 14, 2015

(54) COOKIELESS SYSTEM FOR PROVIDING AD SERVING IN EMAIL WITH DYNAMIC URL REDIRECTION

(71) Applicant: ReachDynamics, LLC, St. Louis, MO (US)

(72) Inventor: Eric L. Castelli, Columbia, IL (US)

(21) Appl. No.: 14/533,854

(22) Filed: Nov. 5, 2014

Related U.S. Application Data
(60) Provisional application No. 61/901,648, filed on Nov. 8, 2013.

(51) Int. Cl. G06Q 30/02; G06Q 10/10

(52) U.S. Cl. CPC G06Q 30/0255; G06Q 10/107
USPC 705/14.53

(57) ABSTRACT

The cookieless system and methods for providing ad serving in email with dynamic URL redirection provided herein overcomes the inherent challenge of supporting fully dynamic ads in email with the ability to dynamically redirect users based on the advertisement displayed without the use of cookies.

### CROSS REFERENCE TO RELATED APPLICATIONS

This application claims the benefit of U.S. Provisional Application No. 61/901,648, filed on Nov. 8, 2013 and entitled “Cookieless System for Providing Ad Serving in Email with Dynamic URL Redirection”, the entire disclosure of which is incorporated herein by reference.

### FIELD OF THE INVENTION

The present disclosure relates generally to the display of advertisements in email, and more particularly, systems and methods for dynamically displaying advertising content and managing dynamic click redirection for advertisements displayed in email.

### BACKGROUND OF THE INVENTION

Email newsletter senders and transactional email senders have historically had few options to monetize their emails. Largely they relied on selling email “ad slots” on a one-off basis. That's because unlike web sites which support scripting technologies like JavaScript, email does not support dynamic scripting of content. The HTML and text of an email cannot be changed once it's sent and thus in order to display advertisements in email they have to be “static” in nature. In other words, the sender must explicitly place the image and URL for a specific advertisement prior to sending the email.

Some have proposed solving the static nature of displaying advertising in email by dynamically rendering images in the email. This works because typically images in an email are nothing more than links to an actual image on a server and aren't directly embedded in the email. Thus, when a user views an email with an image, the image can be dynamically rendered. However, while one could dynamically render different images for different advertisements, the static nature of email prohibits changing the HREF, or hyperlink, in the email. This means that there's no way to dynamically change where the user is redirected to once they click a link for an ad.

So while dynamically returning a different image can be accomplished to “rotate” advertisements, there is no simple mechanism to change the HREF of where the user redirects once the image is clicked. And without being able change where an advertisement redirects the user once clicked, image rotation does little more than allow for different images to be displayed for the same advertisement (such as a different version for those viewing on a mobile device).

One way to overcome the static nature of the HREF of an email advertisement is to simply have a basic time-based redirection system. In such a system one advertisement is shown at any given time, with possible variations of the actual image. When the user clicks the advertisement the currently set link tied to the image advertisement is redirected to by the ad server. The image and link, of course, could then be changed over time. However, the drawback of such a time-based redirection system is that only one advertisement can be displayed at any point in time. As a result, the ability to change the advertisement completely based on the user viewing the ad cannot be achieved since the HREF of the click link cannot be dynamically changed.

Some have suggested that the way to provide truly dynamic advertising with dynamic URL redirection is through the use of cookies. In such a model when a specific advertisement is displayed a cookie is set which indicates the advertisement served. Then when a user clicks on the given advertisement, the user's cookies are inspected to determine the advertisement which was displayed in order to redirect the user to the proper location.

There are inherent flaws with a cookie-based system for dynamic dick redirection in email. Largely, cookies are generally only supported in web-based mail clients. Many mail clients and mobile mail clients either block cookies or simply do not support them. Also, users may disable cookies in their browser. This in turn undermines the ability for a cookie-based system to support accurate dynamic advertising in email. Therefore, there is a need for a cookie-less system for dynamic advertising in email.

### SUMMARY OF THE INVENTION

In one aspect, the present disclosure provides a method for providing dynamic ad serving in an email, including providing, using one or more computing devices, an ad unit identifier corresponding to an ad unit in an email to a user; generating, using the one or more computing devices, an ad image load request when the user views the email, the ad image load request comprising the ad unit identifier, a user identifier, and at least one user attribute; dynamically selecting and retrieving, using the one or more computing devices, an ad image from a pool of available advertisement images corresponding to the ad unit identifier in response to the ad unit image load request, where the dynamic selection of the ad image references at least a portion of at least one impression data entry; displaying, using the one or more computing devices, the ad image in the email; and recording, using the one or more computing devices, an impression data entry associated with the user identifier, the impression data entry comprising the ad image and at least one user attribute from the ad unit image load request.

In another aspect, the present disclosure further includes retrieving, using the one or more computing devices, the ad image of the impression data entry from the impression data store in response to the user clicking the ad image displayed in the email; retrieving, using the one or more computing devices, a redirect URL corresponding to the ad image in response to the user clicking the ad image displayed in the email; and returning, using the one or more computing devices, the redirect URL to the user. In yet another aspect, the method may further include storing, using the one or more computing devices, the ad unit and ad unit information in a data store; where the ad unit includes at least two advertisements. The ad unit information is selected from size of the advertisements, number of advertisements, types of advertisements, specific advertisements, ad images, ad colors, ad layouts, negative keyword targets, and combinations thereof. The ad image is clickable by the user. The method may further include creating, using the one or more computing devices, an ad unit code comprising the ad unit identifier. The ad unit code is provided in the email to the user. At least one user attribute is selected from an impression date including the date the user views the email, an impression time including the time the user views the email, a user IP address, a user agent, a user device, a user email address, a derivative of the user email address, a user location, a randomly generated number, a randomly generated variable, and combinations thereof. At least one user attribute determines which ad image in the ad unit is displayed to the user.

In an aspect, the present disclosure provides a system for providing dynamic ad serving in an email, including: at least one processor, a dynamic ad application comprising a plurality of modules executable on at least one processor, the plurality of modules including: an image load request module to identify an ad unit image load request generated by a user viewing the email, the ad image load request comprising an ad unit identifier corresponding to an ad unit, a user identifier, and at least one user attribute; a dynamic ad unit lookup module to dynamically select and retrieve an ad image from a pool of available advertisement images corresponding to the ad unit identifier in response to the ad unit image load request, where the dynamic selection of the ad image references at least a portion of at least one impression data entry; an image serving module to display the ad image to the user; and an impression recording module for recording an impression data entry associated with the user identifier in the impression data store, the impression data entry comprising the ad image and at least one user attribute from the ad unit image load request.

In another aspect, the plurality of modules further include: a redirection ad retrieval module for retrieving the ad image of the impression data entry associated with the user identifier from the impression data store; a redirection lookup module for retrieving a redirect URL corresponding to the ad image; and a redirection return module for returning the redirect URL to the user. The plurality of modules further include: an ad unit definition module for storing the ad unit and ad unit information in a data store; and a unique identifier module for assigning the ad unit identifier to the ad unit and storing the ad unit identifier in the data store. The ad unit information is selected from size of the advertisements, number of advertisements, types of advertisements, specific advertisements, ad images, colors, layouts, negative keyword targets, and combinations thereof. The ad image is clickable by the user. The plurality of modules further includes an ad unit code module for creating an ad unit code comprising the ad unit identifier. The ad unit code is passed in the email to the user. At least one user attribute is selected from an impression date including the date the user views the email, an impression time including the time the user views the email, a user IP address, a user agent, a user device, a user email address, a derivative of the user email address, a user location, a randomly generated number, a randomly generated variable, and combinations thereof. At least one user attribute determines which ad image in the ad unit is displayed to the user.

### BRIEF DESCRIPTION OF THE DRAWINGS

FIG. 1 is a flow diagram of the cookieless dynamic ad serving method 100 in one aspect.

FIG. 2 is a schematic of the cookieless dynamic ad serving system 200 in one aspect.

FIG. 3 is a schematic overview of a process of the cookieless system and method for ad serving in email with dynamic URL redirection.

### DETAILED DESCRIPTION

Provided herein is a cookieless system and methods for dynamically serving advertisements in email which allows for an unlimited number of advertisements, and thus landing pages, to be rotated in at any time. This, in turn, allows for customizing the exact advertisements being displayed to the user real time, which provides for better relevancy to the user and ultimately improves ad performance.

### A. Methods of Cookieless Dynamic Ad Serving

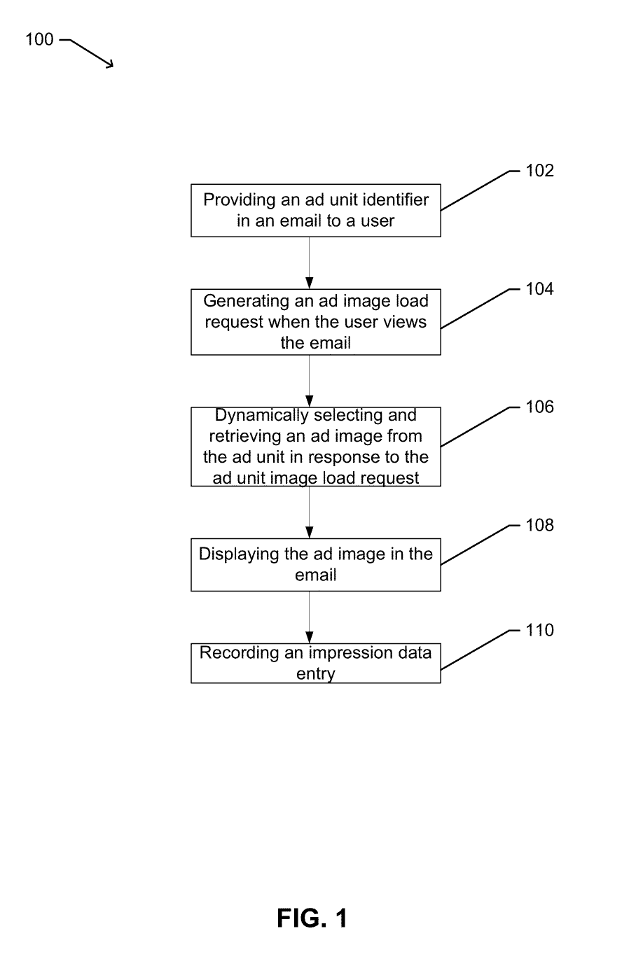

FIG. 1 is a flow diagram of the cookieless dynamic ad serving method 100 in one aspect. The method for providing dynamic ad serving in an email may including providing an ad unit identifier in an email to a user at step 102; generating an ad image load request when the user views the email at step 104; dynamically selecting and retrieving an ad image from the ad unit in response to the ad unit image load request at 106; displaying the ad image in the email at step 108; and recording an impression data entry at step 110.

In an aspect, the ad unit identifier may correspond to an ad unit. The ad unit may include one or more ad images and data associated with an advertiser. In various aspects, the ad image may be an image wrapped in a URL. Non-limiting examples of image formats include JPEG, PNG, GIF, TIFF, BMP, WEBP, or any file format capable of rendering an image. In another aspect, the ad image load request may include the ad unit identifier, a user identifier, and at least one user attribute. The ad unit identifier is an index that may be used to locate an ad unit on computing device, for example on a server. In an aspect, the ad unit identifier may be a number, keyword, or combinations thereof. The user identifier is an index that may be used to identify specific recipient of email. In an aspect, the user identifier may be a number, keyword, email address, username, server ID, or any other unique identifier of the user. The user attribute is a data entry that may be used to characterize a user and/or a select ad image. At least one user attribute may include but is not limited to an impression date, an impression time, a user IP address, a user agent, a user device, a user email address, a derivative of the user email address, a user location, a randomly generated number, a randomly generated variable, and combinations thereof. The impression date and the impression time may be a date and a time, respectively at which the user views the email. At least one user attribute may determine which ad image in the ad unit is displayed to the user. The use of an ad unit identifier, a user identifier, and at least one user attribute allows the ad image to be dynamically displayed to a user and the ad image may change each time the user views the email, without the use of cookies.

At least one impression data entry may be associated with the user identifier. Each impression entry may include at least one user attribute. In an aspect, the ad image is retrieved from a pool of available advertisement images corresponding to the ad unit identifier and the dynamic selection of the ad image may reference at least a portion of at least one impression data entry. The impression data entry may be associated with the user identifier. In an aspect, the impression data entry may include the ad image and at least one user attribute from the ad unit image load request. In an aspect, the ad image displayed may be selected by dynamic selection, sequential selection, or impression data selection. Dynamic selection may use any known method for selection including random selection. Selection in sequential order may be based on known previous views by the user. Selection according to other impression data may include including time of day, location of user, or any other user attributes.

In another aspect, the present disclosure may further include retrieving the ad image of the impression data entry from the impression data store in response to the user clicking the ad image displayed in the email; retrieving a redirect URL corresponding to the ad image in response to the user clicking the ad image displayed in the email; and returning the redirect URL to the user. The redirect URL corresponds to the ad image clicked by the user, so that the user is directed to the appropriate URL for the image they clicked. Optionally the method may further include retrieving at least one impression data entry from an impression data store in response to the ad unit image load request. In yet another aspect, the method may further include storing the ad unit and ad unit information in a data store. In an aspect, the ad unit may include at least two advertisements. In various aspects, the ad unit may include but is not limited to 2 to 10 advertisements, 5 to 15 advertisements, 10 to 20 advertisements, or 15 to 30 advertisements, 20 to 200 advertisements, or more. The ad unit information may be but is not limited to size of the advertisements, number of advertisements, types of advertisements, specific advertisements, ad images, ad colors, ad layouts, negative keyword targets, and combinations thereof. In an aspect, the ad image may be clickable by the user. The method may further include creating an ad unit code including the ad unit identifier. In an aspect, the ad unit code may be provided in the email to the user.

### B. Systems for Cookieless Dynamic Ad Serving

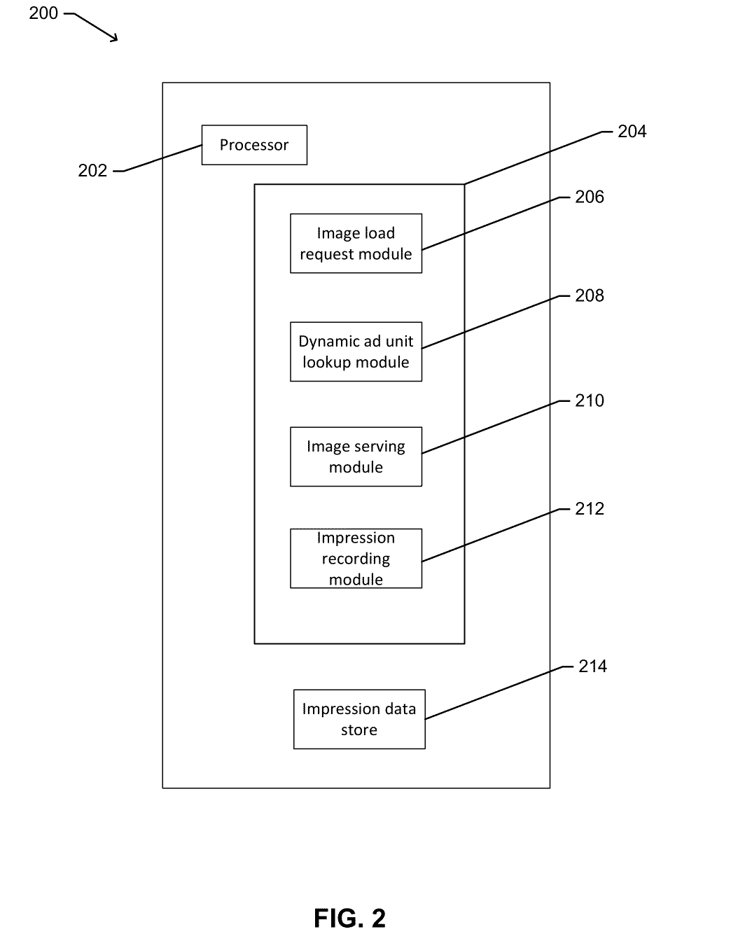

FIG. 2 is a schematic of the cookieless dynamic ad serving system 200 in one aspect. In an aspect, the system for providing dynamic ad serving in an email may include at least one processor 202 and a dynamic ad application 204 including a plurality of modules executable on at least one processor. The plurality of modules may include an image load request module 206; a dynamic ad unit lookup module 208; an image serving module 210; and an impression recording module 212.

In an aspect, the image load request module may identify an ad unit image load request generated by a user viewing the email. The ad image load request may include an ad unit identifier corresponding to an ad unit, a user identifier, and at least one user attribute. In an aspect, each impression entry comprising at least one user attribute. The dynamic ad unit lookup module may dynamically select and retrieve an ad image from a pool of available advertisement images corresponding to the ad unit identifier in response to the ad unit image load request. In an aspect, the dynamic selection of the ad image may reference at least a portion of at least one impression data entry. The image serving module may display the ad image to the user. The impression recording module may record an impression data entry associated with the user identifier in the impression data store 214. In an aspect, the impression data entry may include the ad image and at least one user attribute from the ad unit image load request.

Optionally, the system may include additional modules. In an aspect, the plurality of modules may further include a redirection ad retrieval module for retrieving the ad image of the impression data entry associated with the user identifier from the impression data store 214; a redirection lookup module for retrieving a redirect URL corresponding to the ad image; and a redirection return module for returning the redirect URL to the user. Optionally, the plurality of modules may further include an impression retrieval module to retrieve at least one impression data entry associated with the user identifier from an impression data store 214 in response to the ad unit image load request. In another aspect, the plurality of modules may further include an ad unit definition module for storing the ad unit and ad unit information in a data store 214; and a unique identifier module for assigning the ad unit identifier to the ad unit and storing the ad unit identifier in the data store 214. The ad unit information may include but is not limited to size of the advertisements, number of advertisements, types of advertisements, specific advertisements, ad images, colors, layouts, negative keyword targets, and combinations thereof. The ad image is clickable by the user. In another aspect, the plurality of modules may further include an ad unit code module for creating an ad unit code comprising the ad unit identifier. The ad unit code may be passed in the email to the user. At least one user attribute may include but is not limited to an impression date, an impression time, a user IP address, a user agent, a user device, a user email address, a derivative of the user email address, a user location, a randomly generated number, a randomly generated variable, and combinations thereof. In an aspect, the impression date and the impression time may be a date and a time, respectively, that the user views the email. In another aspect, at least one user attribute may determine which ad image in the ad unit is displayed to the user.

### EXAMPLES

The following examples are provided for exemplary guidance to use the system and methods according to the inventive subject matter. However, it should be recognized that numerous modifications may be made without departing from the inventive concept presented herein.

### Example 1

### Cookieless Dynamic Ad Serving

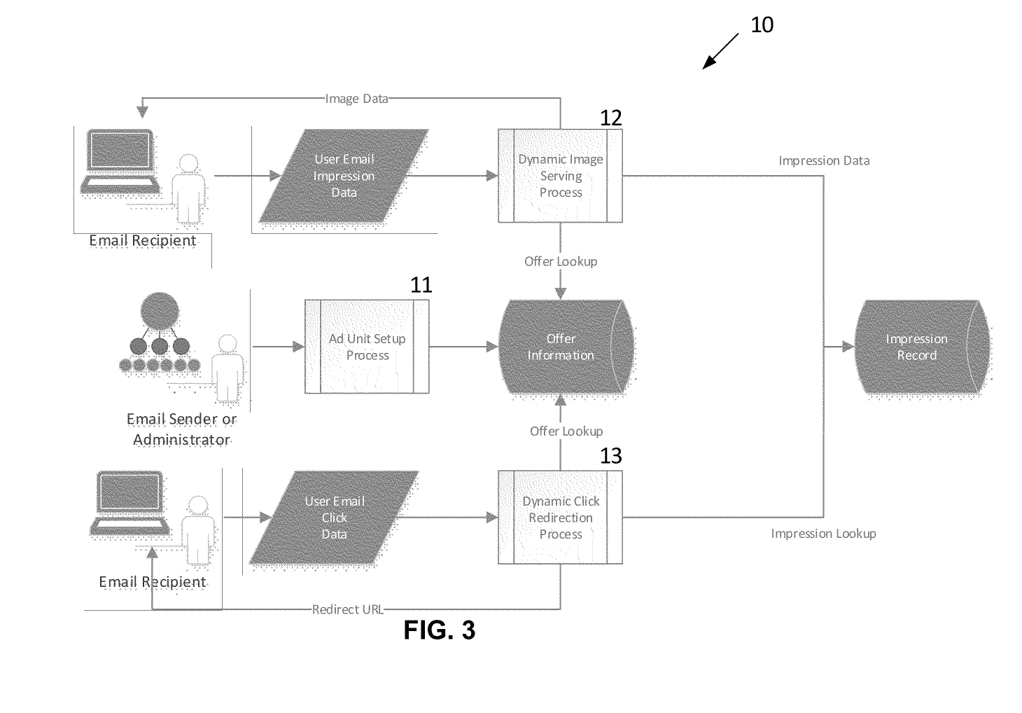

FIG. 3 illustrates the cookieless methods and system 10 for providing ad serving in email with dynamic URL redirection. In an aspect, the method may include an ad unit setup process 11, a dynamic image serving process 12, and a dynamic click redirection process 13. Generally, the system 10 and methods may allow for the definition of ad units 11 or placeholders for advertisements in email. The dynamic image serving process 12 may be responsible for responding to ad unit image load requests and recording the advertisement or offer displayed and unique information about the individual who viewed the advertisement in a central data store. The dynamic click redirection process 13 may be responsible for looking up and returning the redirect URL for the click based on the ad unit and information stored about the viewing user and advertisement displayed during the dynamic image serving process 12.

### Example 2

### Ad Unit Setup

In the ad unit set up process 11 an email publisher or an administrator may define an ad unit. An ad unit is a placeholder for where an advertisement may be displayed in an email much like that defined in typical web-based advertising services like Google AdSense. During the ad unit setup process, the publisher may define information about the ad unit, such as the size of the ad unit and the types of advertisements to display or in some embodiments, specific ads which may be displayed. Once created, the ad unit information is stored in a data store for later retrieval. HTML code for the ad unit is then provided to the email sender for insertion into their email templates. One or more identifiers may then be included in the ad unit code, which when combined create a unique identifier of the ad unit, such as in this basic example HTML code:
<a href=“http//e-find.co/c/1”><img src=“http://e-find.co/img/1”/></a>
   In this example, the number “1” in the ad unit HTML code is used to uniquely identify the specific ad unit when image loads and clicks occur in the emails the ad unit is inserted into.

### Example 3

### Dynamic Image Serving

When a user receives an email with the ad unit code defined in the ad unit setup process 11, the HTML image code for the ad unit is triggered when the email is viewed. Using the example image URL above, an image load request would be made to http://e-find.co/img/1, where 1 is the unique identifier of the ad unit. When the image load request is made to the dynamic image serving process 12, the unique identifier for the ad unit is used to look up information about the ad unit in order to determine what advertisement image to return. As detailed in the ad unit set up process 11, specific advertisements may have been defined for display or advertisements may be dynamically selected from a pool of available advertisements. The process of selecting the image and advertisement to display may include using information collected about the user, including geo location based on their IP address, device type based on their user agent or even specific user information based on unique identifiers passed in the ad unit image URL (for example, their email address).

During the dynamic image serving process 12, information about the user viewing the email is also collected. While not inclusive, this may include the IP address of the user viewing the image, the user agent of the user's browser, as well as the referrer URL of the image request. Additionally, one or more unique identifiers of the recipient may also be embedded into outbound emails by the email publisher as demonstrated in the examples below.

<img src=″http://e-find.co/img/1?email=abc@bab.com″/>
<img src=″http//e-find.co/img/1?emailhash=md5hash″/>
<img src=″http://e-find.co/img/1?emailid=123456″/>

The ad unit Id, the advertisement returned by the dynamic image server process and the user's information is then stored to record the impression. A simple example of how this data could be stored is as follows:

| | | | Publisher | | | |
|---|---|---|---|---|---|---|
| Impression | Ad Unit | Impression | User | User IP | | Advertisement |
| Id | Id | Date | Email ID | Address | User Agent | ID Shown |
| 1 | 1 | Nov. 5, 2013 | 123456 | 127.0.0.1 | Mozilla/4.0 | 1001 |
| | | 8:00 AM | | | (compatible; | |
| | | | | | MSIE 7.0; | |
| | | | | | Windows | |
| | | | | | NT 6.0) | |

Alternatively, rather than storing each of these items as separate data points, a “fingerprint” of the user could be created by combining one or more attributes of the user impression data in order to record the advertisement displayed to the user.

### Example 4

### Dynamic Click Redirection

Once the impression is recorded by the dynamic image serving process 12, either a raw image may be returned by this process or the image serving process may simply redirect the request to the ultimate destination of where the image resides. In either case, the returned image is ultimately displayed in the user's email. The image of an ad unit is clickable by the user. This could be accomplished through various methods in HTML, but a simple implementation of this is to wrap the image in a URL such as this:
<a href=“http//e-find.co/c/1”><img src=“http://e-find.co/img/1”></a>

In an email, when the user clicks the link surrounding the image in the example above, the user is redirected to http://e-find.co/c/1, where the logic of the dynamic click redirection process 13 occurs. In this example, the ad unit Id is 1, but the click URL can't be dynamically changed in the email. Thus, the URL doesn't allow us to know what advertisement image was displayed to the user. However, the information stored about the user in the image serving process 12 can now be used to determine what advertisement was last shown to the user. The same information collected about the user during the impression in the dynamic image serving process 12 can also be easily retrieved during the click, including the IP of the user, the user agent of the user's browser and the referral URL of the request, when available. Likewise, in addition to browser and client information, a unique identifier of the recipient may also be embedded into outbound emails by the email publisher as demonstrated in the example below:

<a href=http://e-find.co/c/1?emailid=123456><img src=″http://e-
find.co/img/1?emailid=123456″″/> </a>
\

Using the user information collected, the dynamic click redirection process 13, then looks at the impression data store to determine the last advertisement displayed to the user for the given ad unit id. In the below example history stored during the dynamic image serving process 12, it can be seen that the user has been shown 2 ads for ad unit 1. However, the last ad he viewed for this ad unit was Advertisement ID 1002. Thus, it's clear that the user is clicking on the 1002 advertisement. Using this information, a look up can then be performed to determine the URL of the offer for the advertisement. This may be stored in a separate data store with ad unit information, a separate offer list, or directly when recording the impression. Regardless, this lookup is used to determine the ultimate offer landing page and the click is redirected to the corresponding offer using standard web based redirects such as an HTTP 301 Redirect.

| | | | Publisher | | | |
|---|---|---|---|---|---|---|
| Impression | Ad Unit | Impression | User | User IP | | Advertisement |
| Id | Id | Date | Email ID | Address | User Agent | ID Shown |
| 1 | | Nov. 5, 2013 | 123456 | 127.0.0.1 | Mozilla/4.0 | 1001 |
| | | 8:00 AM | | | (compatible; | |
| | | | | | MSIE 7.0; | |
| | | | | | Windows | |
| | | | | | NT 6.0) | |
| 2 | 1 | Nov. 6, 2013 | 123456 | 127.0.0.1 | Mozilia/4.0 | 1002 |
| | | 9:20 PM | | | (compatible; | |
| | | | | | MSIE 7.0; | |
| | | | | | Windows | |
| | | | | | NT 6.0) | |

In view of the foregoing, it will be seen that several advantages of the present disclosure are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Additionally, it will be appreciated that the information used to uniquely identify a given email user may change as new methods of identifying online users evolve. For example, if new technology allows for the retrieval of a unique user identifier in an HTTP request, this may be leveraged in storing and determine the last advertisement displayed to a given user.

What is claimed is:

1. A method for providing dynamic ad serving in an email, comprising:
providing, using one or more computing devices, an ad unit identifier corresponding to an ad unit in an email to a user;
generating, using the one or more computing devices, an ad image load request when the user views the user views the email, the ad image load request comprising the ad unit identifier, a user identifier, and at least one user attribute;
dynamically selecting and retrieving, using the one or more computing devices, an ad image from a pool of available advertisement images corresponding to the ad unit identifier in response to the ad unit image load request, wherein the dynamic selection of the ad image references at least a portion of the at least one impression data entry;
displaying, using the one or more computing devices, the ad image in the email; and
recording, using the one or more computing devices, an impression data entry associated with the user identifier, the impression data entry comprising the ad image and the at least one user attribute from the ad unit image load request.

2. The method of claim 1, further comprising:
retrieving, using the one or more computing devices, the ad image of the impression data entry from the impression data store in response to the user clicking the ad image displayed in the email;
retrieving, using the one or more computing devices, a redirect URL corresponding to the ad image in response to the user clicking the ad image displayed in the email; and
returning, using the one or more computing devices, the redirect URL to the user.

3. The method of claim 1, further comprising:
storing, using the one or more computing devices, the ad unit and ad unit information in a data store;
wherein the ad unit comprises at least two advertisements.

4. The method of claim 3, wherein the ad unit information is selected from a group consisting of size of the advertisements, number of advertisements, types of advertisements, specific advertisements, ad images, ad colors, ad layouts, negative keyword targets, and combinations thereof.

5. The method of claim 1, wherein the ad image is clickable by the user.

6. The method of claim 1, further comprising creating, using the one or more computing devices, an ad unit code comprising the ad unit identifier.

7. The method of claim 5, wherein the ad unit code is provided in the email to the user.

8. The method of claim 1, wherein the at least one user attribute is selected from the group consisting of an impression date comprising a date the user views the email, an impression time comprising a time the user views the email, a user IP address, a user agent, a user device, a user email address, a derivative of the user email address, a user location, a randomly generated number, a randomly generated variable, and combinations thereof.

9. The method of claim 8, wherein the at least one user attribute determines which ad image in the ad unit is displayed to the user.

10. A system for providing dynamic ad serving in an email, comprising:
at least one processor,
a dynamic ad application comprising a plurality of modules executable on the at least one processor, the plurality of modules comprising:
an image load request module to identify an ad unit image load request generated by a user viewing the email, the ad image load request comprising an ad unit identifier corresponding to an ad unit, a user identifier, and at least one user attribute;
a dynamic ad unit lookup module to dynamically select and retrieve an ad image from a pool of available advertisement images corresponding to the ad unit identifier in response to the ad unit image load request, wherein the dynamic selection of the ad image references at least a portion of the at least one impression data entry;
an image serving module to display the ad image to the user; and
an impression recording module for recording an impression data entry associated with the user identifier in the impression data store, the impression data entry comprising the ad image and the at least one user attribute from the ad unit image load request.

11. The system of claim 10, wherein the plurality of modules further comprise:
a redirection ad retrieval module for retrieving the ad image of the
impression data entry associated with the user identifier from the impression data store;
a redirection lookup module for retrieving a redirect URL corresponding to the ad image; and
a redirection return module for returning the redirect URL to the user.

12. The system of claim 10, wherein the plurality of modules further comprise:
an ad unit definition module for storing the ad unit and ad unit information in a data store; and
a unique identifier module for assigning the ad unit identifier to the ad unit and storing the ad unit identifier in the data store.

13. The system of claim 12, wherein the ad unit information is selected from a group consisting of size of the advertisements, number of advertisements, types of advertisements, specific advertisements, ad images, colors, layouts, negative keyword targets, and combinations thereof.

14. The system of claim 10, wherein the ad image is clickable by the user.

15. The system of claim 10, wherein the plurality of modules further comprise an ad unit code module for creating an ad unit code comprising the ad unit identifier.

16. The system of claim 15, wherein the ad unit code is passed in the email to the user.

17. The system of claim 10, wherein the at least one user attribute is selected from the group consisting of an impression date comprising a date the user views the email, an impression time comprising a time the user views the email, a user IP address, a user agent, a user device, a user email address, a derivative of the user email address, a user location, a randomly generated number, a randomly generated variable, and combinations thereof.

18. The system of claim 17, wherein the at least one user attribute determines which ad image in the ad unit is displayed to the user.

19. A method for providing dynamic ad serving in an email, comprising:
providing, using one or more computing devices, an ad unit identifier corresponding to an ad unit in an email to a user;
generating, using the one or more computing devices, an ad image load request when the user views the email, the ad image load request comprising the ad unit identifier, a user identifier, and at least one user attribute;
dynamically selecting and retrieving, using the one or more computing devices, an ad image from a pool of available advertisement images corresponding to the ad unit identifier in response to the ad unit image load request, wherein the dynamic selection of the ad image references at least a portion of the at least one impression data entry;
displaying, using the one or more computing devices, the ad image in the email;
recording, using the one or more computing devices, an impression data entry associated with the user identifier, the impression data entry comprising the ad image and the at least one user attribute from the ad unit image load request.
retrieving, using the one or more computing devices, the ad image of the impression data entry from the impression data store in response to the user clicking the ad image displayed in the email;
retrieving, using the one or more computing devices, a redirect URL corresponding to the ad image in response to the user clicking the ad image displayed in the email; and
returning, using the one or more computing devices, the redirect URL to the user.
